(19) United States
(12) Patent Application Publication
(10) Pub. No.: US 2023/0327516 A1
(43) Pub. Date: Oct. 12, 2023

(54) MOTOR ROTOR AND TURBOCHARGER

(71) Applicant: IHI Corporation, Tokyo (JP)

(72) Inventor: Katsunori HAYASHI, Tokyo (JP)

(21) Appl. No.: 18/334,469

(22) Filed: Jun. 14, 2023

Related U.S. Application Data
(63) Continuation of application No. PCT/JP2022/007645, filed on Feb. 24, 2022.

(30) Foreign Application Priority Data
Mar. 26, 2021 (JP) 2021-052829

(51) Int. Cl. H02K 7/18; H02K 1/28; H02K 7/00

(52) U.S. Cl. CPC H02K 7/1823; H02K 1/28; H02K 7/003

(57) ABSTRACT

A motor rotor 11 includes: a holding portion 131 having a tubular shape, a first shaft 61 inserted into one side of the holding portion 131, a second shaft 62 inserted into the other side of the holding portion 131, a permanent magnet 14 provided between the first shaft 61 and the second shaft 62 inside the holding portion 131, and a partition wall portion 132 provided between the first shaft 61 and the second shaft 62 inside the holding portion 131. The partition wall portion 132 forms a rigid body, together with the holding portion 131, the first shaft 61, and the second shaft 62.

### CROSS-REFERENCE TO RELATED APPLICATIONS

This application is a continuation application of PCT Application No. PCT/JP2022/007645, filed on Feb. 24, 2022, which claims the benefit of priority from Japanese Patent Application No. 2021-052829, filed on Mar. 26, 2021. The entire contents of the above listed PCT and priority applications are incorporated herein by reference.

### BACKGROUND

The present disclosure relates to a motor rotor and a turbocharger.

An electric turbocharger disclosed in Japanese Unexamined Patent Publication No. 2014-50133 is known as a technique related to a motor rotor. The motor rotor disclosed in Patent Literature 1 includes a shaft, a magnet provided around the shaft, and a holding portion having a tubular shape and covering an outer peripheral surface of the magnet. The holding portion applies a compressive load to the magnet such that the magnet does not detach from the shaft even in a situation where a large centrifugal force acts at the maximum rotation speed.

In the motor rotor described above, miniaturization may be required. In order to realize the miniaturization of the motor rotor, for example, a configuration can be considered in which the shaft is divided into two parts inside the holding portion and the magnet is disposed between the two shafts. However, in such a case, there is a risk that the rigidity of the motor rotor decreases.

Therefore, an object of the present disclosure is to provide a motor rotor and a turbocharger capable of suppressing a decrease in rigidity.

### SUMMARY

According to one aspect of the present disclosure, a motor rotor includes: a holding portion having a tubular shape, a first shaft inserted into one side of the holding portion, a second shaft inserted into the other side of the holding portion, a magnet provided between the first shaft and the second shaft inside the holding portion, and a partition wall portion provided between the first shaft and the second shaft inside the holding portion. The partition wall portion forms a rigid body, together with the holding portion, the first shaft, and the second shaft.

According to one aspect of the present disclosure, a turbocharger includes the motor rotor described above. The motor rotor includes a compressor impeller provided on a side of the second shaft which is opposite from the first shaft.

According to the present disclosure, it is possible to provide the motor rotor and the turbocharger capable of suppressing a decrease in rigidity.

### BRIEF DESCRIPTION OF THE DRAWINGS

FIG. 1 is a cross-sectional view of a turbocharger according to one embodiment.

FIG. 2 is an enlarged view of a portion II in FIG. 1.

FIG. 3 is an enlarged view of a turbocharger according to a modification example.

FIG. 4 is an enlarged view of a turbocharger according to a modification example.

### DETAILED DESCRIPTION

According to one aspect of the present disclosure, a motor rotor includes: a holding portion having a tubular shape, a first shaft inserted into one side of the holding portion, a second shaft inserted into the other side of the holding portion, a magnet provided between the first shaft and the second shaft inside the holding portion, and a partition wall portion provided between the first shaft and the second shaft inside the holding portion. The partition wall portion forms a rigid body, together with the holding portion, the first shaft, and the second shaft.

In the motor rotor, the first shaft is inserted into the one side of the holding portion, the second shaft is inserted into the other side of the holding portion, and the magnet is provided between the first shaft and the second shaft inside the holding portion. Accordingly, for example, compared to the case where a magnet is disposed on an outer periphery of a shaft, miniaturization of the motor rotor can be achieved. Moreover, the partition wall portion is provided between the first shaft and the second shaft, and the partition wall portion forms a rigid body, together with the holding portion, the first shaft, and the second shaft. Accordingly, a decrease in the rigidity of the motor rotor can be suppressed.

The magnet may be each of a plurality of magnets. The partition wall portion may be provided between the plurality of magnets. Accordingly, the degree of freedom in designing each of the plurality of magnets and the partition wall portion can be improved.

The partition wall portion may be provided between at least one of the first shaft and the second shaft, and the magnet. Accordingly, a decrease in the rigidity of the motor rotor can be suppressed with a simple configuration.

A rigidity of the partition wall portion may be larger than a rigidity of the magnet. Accordingly, a decrease in the rigidity of the motor rotor can be reliably suppressed.

Each of the holding portion and the partition wall portion may be a part of the holding member. Accordingly, the cost can be reduced and the productivity can be improved by reducing the number of components.

The partition wall portion may be formed separately from the holding portion. Accordingly, the degree of freedom in designing each of the holding portion and the partition wall portion can be improved.

According to one aspect of the present disclosure, a turbocharger includes the motor rotor. The motor rotor includes a compressor impeller provided on a side of the second shaft which is opposite from the first shaft.

According to the turbocharger, as described above, a decrease in the rigidity of the motor rotor can be suppressed.

Hereinafter, an embodiment of the present disclosure will be described in detail with reference to the drawings. It should be noted that in each of the drawings, the same or equivalent portions are denoted by the same reference signs, and duplicate descriptions will be omitted.

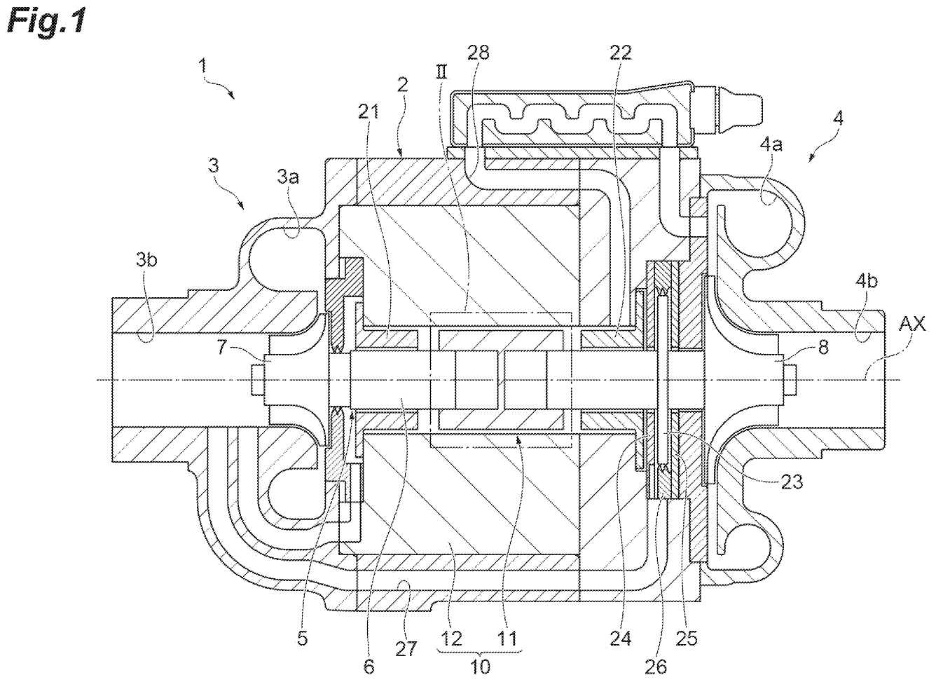

As shown in FIG. 1, a turbocharger 1 is an electric turbocharger. The turbocharger 1 is applied to, for example, internal combustion engines for ships or vehicles. The turbocharger 1 includes an electric motor 10, a motor housing 2, a turbine housing 3, and a compressor housing 4. The electric motor 10 includes a rotating body 5. The rotating body 5 includes a shaft 6, a turbine impeller 7, and a compressor impeller 8.

The shaft 6 has, for example, a columnar shape. The turbine impeller 7 is provided at one end of the shaft 6. The compressor impeller 8 is provided at the other end of the shaft 6. The motor housing 2 is provided between the turbine impeller 7 and the compressor impeller 8. The rotating body 5 is rotatably supported by the motor housing 2. Specifically, the shaft 6 is accommodated in the motor housing 2. A pair of bearings 21 and 22 are provided between the shaft 6 and the motor housing 2. The bearings 21 and 22 support the shaft 6 in a radial direction at both end portions of the shaft 6.

The shaft 6 includes a thrust collar 23 provided on a compressor impeller 8 side. The thrust collar 23 protrudes in a radial direction of the shaft 6. The thrust collar 23 has, for example, a disk shape. A pair of air bearings 24 and 25 are provided on both sides of the thrust collar 23 in an axial direction of the shaft 6. A spacer 26 surrounding the thrust collar 23 is provided between the pair of air bearings 24 and 25.

The pair of air bearings 24 and 25 and the spacer 26 are integrally fastened together by a plurality of fastening bolts. The air bearings 24 and 25 and the spacer 26 that are integrated are fixed inside the motor housing 2. The air bearings 24 and 25 and the spacer 26 define an accommodation space in which the thrust collar 23 is accommodated. The accommodation space supports the shaft 6 in a thrust direction. The thrust collar 23 is rotatable in the state of non-contact with the air bearings 24 and 25 and the spacer 26 within the accommodation space.

The turbine housing 3 accommodates the turbine impeller 7. The turbine housing 3 forms a turbine, together with the turbine impeller 7. The turbine housing 3 has a scroll passage 3a. The scroll passage 3a extends around the turbine impeller 7 in a circumferential direction centered on an axis AX of the shaft 6 (hereinafter, simply referred to as the “circumferential direction”).

The turbine housing 3 has an inlet and an outlet 3b. Exhaust gas discharged from an internal combustion engine flows into the turbine housing 3 through the inlet. The exhaust gas that has flowed into the turbine housing 3 flows into the turbine impeller 7 through the scroll passage 3a. Then, the exhaust gas rotates the turbine impeller 7. Thereafter, the exhaust gas flows to the outside of the turbine housing 3 through the outlet 3b.

The compressor housing 4 accommodates the compressor impeller 8. The compressor housing 4 forms a compressor, together with the compressor impeller 8. The compressor housing 4 has a scroll passage 4a. The scroll passage 4a extends around the compressor impeller 8 in the circumferential direction.

The compressor housing 4 has an inlet port 4b and an outlet port. When the turbine impeller 7 rotates, the compressor impeller 8 rotates via the shaft 6. The rotating compressor impeller 8 suctions outside air through the inlet port 4b. The air suctioned by the compressor impeller 8 is compressed by passing through the compressor impeller 8 and the scroll passage 4a. The air is discharged from the outlet port as compressed air. The compressed air is supplied to the internal combustion engine.

An air discharge passage 27 is formed continuously in the motor housing 2 and the turbine housing 3. The air discharge passage 27 communicates the accommodation space defined by the air bearings 24 and 25 and the spacer 26 with the outlet 3b of the turbine housing 3. During operation of the turbocharger 1, air in the accommodation space is discharged little by little to the outside through the air discharge passage 27 and the outlet 3b.

A cooling air passage 28 is formed in the motor housing 2. The cooling air passage 28 communicates a space, in which the bearings 21 and 22 are provided, with the compressor housing 4. Some of air flowing through the compressor housing 4 flows into the space, in which the bearings 21 and 22 are provided, through the cooling air passage 28. Accordingly, the bearings 21 and 22 and the like are cooled.

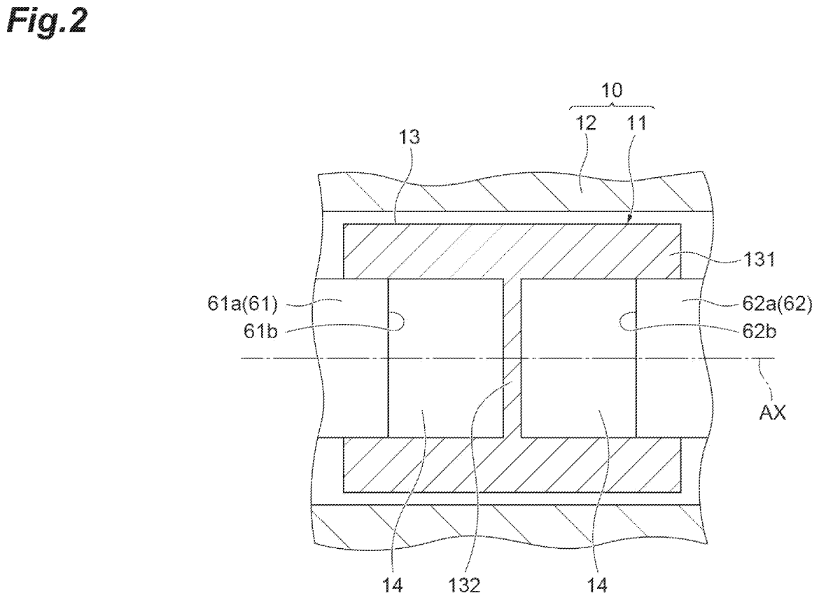

Next, the electric motor 10 will be described. The electric motor 10 is, for example, a brushless AC electric motor. As shown in FIGS. 1 and 2, the electric motor 10 includes a motor rotor 11 which is a rotor, and a motor stator 12 which is a stator. The motor rotor 11 corresponds to the rotating body 5. The motor rotor 11 includes a first shaft 61, a second shaft 62, a holding member 13, a plurality of permanent magnets 14, the turbine impeller 7, and the compressor impeller 8.

Each of the first shaft 61 and the second shaft 62 is a part of the shaft 6. Namely, the shaft 6 is divided into two parts: the first shaft 61 and the second shaft 62. Each of the first shaft 61 and the second shaft 62 has, for example, a columnar shape. The turbine impeller 7 is provided on a side of the first shaft 61 which is opposite from the second shaft 62. The compressor impeller 8 is provided on a side of the second shaft 62 which is opposite from the first shaft 61.

The holding member 13 is provided between the pair of bearings 21 and 22 in the axial direction of the shaft 6. The holding member 13 includes a holding portion 131. The holding portion 131 has, for example, a tubular shape. In the present embodiment, the holding portion 131 has a cylindrical shape. The holding portion 131 may be called an “armour ring” or the like. An end portion 61a of the first shaft 61 on a side which is opposite from the turbine impeller 7 is inserted into one side of the holding portion 131. The end portion 61a of the first shaft 61 is press-fitted into the one side of the holding portion 131. An end portion 62a of the second shaft 62 on a side which is opposite from the compressor impeller 8 is inserted into the other side of the holding portion 131. The end portion 62a of the second shaft 62 is press-fitted into the other side of the holding portion 131.

An end surface 61b of the first shaft 61 on a side which is opposite from the turbine impeller 7 and an end surface 62b of the second shaft 62 on a side which is opposite from the compressor impeller 8 are separated from each other. In the present embodiment, the motor rotor 11 includes two permanent magnets 14. Each of the permanent magnets 14 has, for example, a columnar shape.

Each of the permanent magnets 14 is provided between the first shaft 61 and the second shaft 62 inside the holding portion 131. Each of the permanent magnets 14 is press-fitted into the holding portion 131. One permanent magnet 14 is in contact with the end surface 61b of the first shaft 61. The other permanent magnet 14 is in contact with the end surface 62b of the second shaft 62. The two permanent magnets 14 are separated from each other. Each of the permanent magnets 14 is, for example, a neodymium (Nd—Fe—B) magnet, a samarium cobalt magnet, or the like.

The holding member 13 further includes a partition wall portion 132. The partition wall portion 132 has a plate shape. The partition wall portion 132 is provided between the first shaft 61 and the second shaft 62 inside the holding portion 131. The partition wall portion 132 is provided between the two permanent magnets 14. The partition wall portion 132 has the axial direction of the shaft 6 as a thickness direction. Namely, the partition wall portion 132 extends in a plane perpendicular to the axis AX of the shaft 6. The partition wall portion 132 extends to an inner wall of the holding portion 131. Namely, the partition wall portion 132 extends from the inner wall of the holding portion 131 in a radial direction of the holding portion 131. The partition wall portion 132 is located at approximately the center of the holding portion 131 in the axial direction of the shaft 6.

The partition wall portion 132 is in contact with each of the permanent magnets 14. A rigidity of the partition wall portion 132 may be larger than a rigidity of each of the permanent magnets 14. An elastic modulus of the partition wall portion 132 may be larger than an elastic modulus of each of the permanent magnets 14. Each of the holding portion 131 and the partition wall portion 132 may be a part of the holding member 13. Namely, the holding member 13 including the holding portion 131 and the partition wall portion 132 is formed as one component from the same material. The material of the holding member 13 is, for example, metal. The material of the holding member 13 is, for example, non-magnetic metal such as titanium (for example, Ti-6Al-4V).

The motor rotor 11 is configured as one rigid body with the holding portion 131, the first shaft 61, the second shaft 62, each of the permanent magnets 14, the partition wall portion 132, the turbine impeller 7, and the compressor impeller 8. Namely, the motor rotor 11 is integrally formed. The partition wall portion 132 suppresses a decrease in the bending rigidity of the motor rotor 11. For example, the partition wall portion 132 improves the natural frequency (eigenvalue) of the motor rotor 11 compared to the case where the motor rotor 11 does not include the partition wall portion 132. The natural frequency of the motor rotor 11 including the partition wall portion 132 is larger than the frequency of the motor rotor 11 that operates at the maximum rotation speed.

The motor stator 12 is accommodated in the motor housing 2. The motor stator 12 surrounds the motor rotor 11 in the circumferential direction. The motor stator 12 includes a plurality of coils and a plurality of iron cores. When an electric current is supplied to the coils and the motor stator 12 generates a magnetic field, a circumferential force acts on the motor rotor 11 due to the magnetic field, and as a result, torque is applied to the shaft 6. A driving source of the electric motor 10 is a battery of a vehicle or the like. The electric motor 10 may regeneratively generate electric power using rotational energy of the motor rotor 11 during deceleration of the vehicle. The electric motor 10 has characteristics that allow the electric motor 10 to cope with the high-speed rotation (for example, 100,000 to 200,000 rpm) of the motor rotor 11.

As described above, in the motor rotor 11, the first shaft 61 is inserted into the one side of the holding portion 131, the second shaft 62 is inserted into the other side of the holding portion 131, and the permanent magnets 14 are provided between the first shaft 61 and the second shaft 62 inside the holding portion 131. Accordingly, for example, compared to the case where the permanent magnets are disposed on an outer periphery of the shaft 6, miniaturization of the motor rotor 11 can be achieved. Moreover, the partition wall portion 132 is provided between the first shaft 61 and the second shaft 62. According to the partition wall portion 132, deformation of the holding portion 131 can be suppressed, and a decrease in the rigidity of the holding portion 131 can be suppressed. Further, the partition wall portion 132 forms the motor rotor 11 which is a rigid body, together with the holding portion 131, the first shaft 61, and the second shaft 62. Accordingly, a decrease in the bending rigidity of the motor rotor 11 can be suppressed, and a decrease in the natural frequency of the motor rotor 11 can be suppressed. Therefore, in the rotation range of the motor rotor 11 (the range of rotation speed of the motor rotor 11), the frequency of the motor rotor 11 can be prevented from reaching the natural frequency of the motor rotor 11, and the occurrence of resonance in the motor rotor 11 can be suppressed. In other words, the critical speed range (rotation range) of the motor rotor 11 can be improved.

The partition wall portion 132 is provided between the plurality of permanent magnets 14. Accordingly, the degree of freedom in designing each of the plurality of permanent magnets 14 and the partition wall portion 132 can be improved. For example, the flexibility of the disposition of each of the permanent magnets 14 and the partition wall portion 132 can be improved.

The rigidity of the partition wall portion 132 is larger than the rigidity of each of the permanent magnets 14. Accordingly, a decrease in the rigidity of the motor rotor 11 can be reliably suppressed.

Each of the holding portion 131 and the partition wall portion 132 is a part of the holding member 13. Namely, the holding portion 131 and the partition wall portion 132 are seamlessly formed as an integral member. Alternatively, the holding portion 131 and the partition wall portion 132 may be connected and integrated via a connecting portion. The connection referred to here is not particularly limited as long as the connection is a known method for connecting two members, such as welding. Accordingly, the cost can be reduced and the productivity can be improved by reducing the number of components.

The first shaft 61 is press-fitted into the one side of the holding portion 131, and the second shaft 62 is press-fitted into the other side of the holding portion 131. The partition wall portion 132 is provided between the two permanent magnets 14. Accordingly, a decrease in the rigidity of the motor rotor 11 can be more reliably suppressed.

According to the turbocharger 1, as described above, a decrease in the rigidity of the motor rotor 11 can be suppressed.

One embodiment of the present disclosure has been described above, however, the present disclosure is not limited to the above-described embodiment.

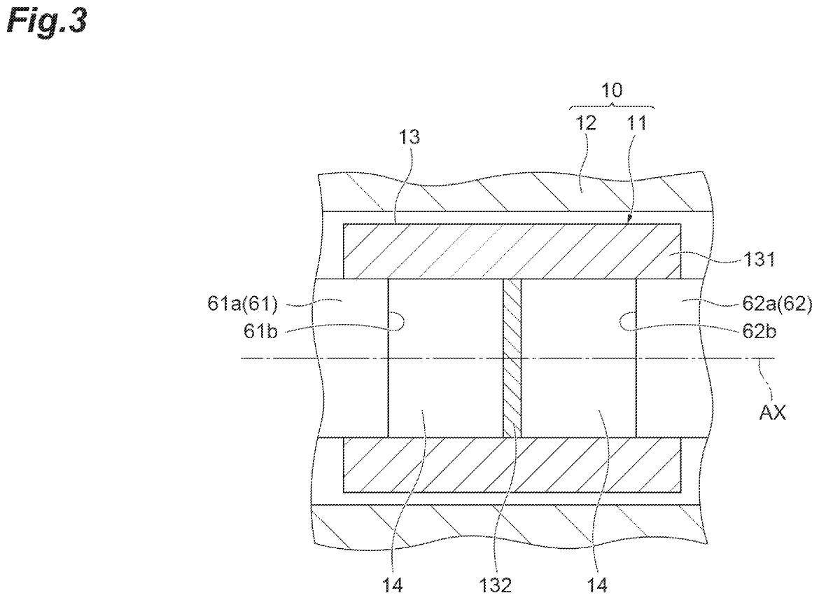

For example, the example in which each of the holding portion 131 and the partition wall portion 132 is a part of the holding member 13 has been described, however, as shown in FIG. 3, the partition wall portion 132 may be formed separately from the holding portion 131. Accordingly, the degree of freedom in designing each of the holding portion 131 and the partition wall portion 132 can be improved. For example, the partition wall portion 132 may be press-fitted into the holding portion 131. For example, the partition wall portion 132 may be connected to the holding portion 131 by welding or the like. The material of the partition wall portion 132 may be different from the material of the holding portion 131.

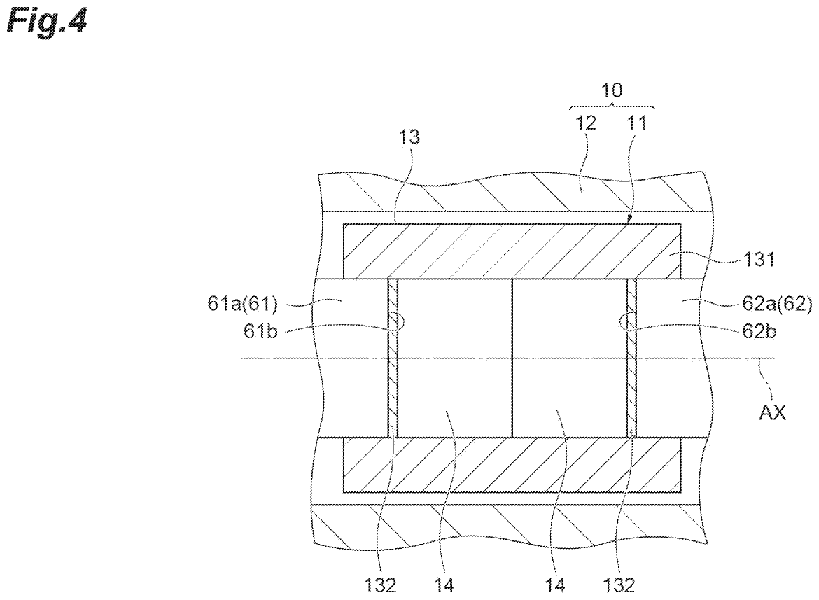

The example in which the partition wall portion 132 is provided between the two permanent magnets 14 has been described, however, as shown in FIG. 4, the partition wall portion 132 may not be provided between the two permanent magnets 14. The partition wall portions 132 may be each provided between the first shaft 61 and one permanent magnet 14 and between the second shaft 62 and the other permanent magnet 14. Namely, the magnet may not be interposed between the second shaft 62 and the partition wall portion 132 located on a second shaft 62 side out of two partition wall portions 132 arranged in the axial direction of the shaft 6. Accordingly, a decrease in the rigidity of the motor rotor 11 can be suppressed with a simple configuration. In this case, one partition wall portion 132 is in contact with each of the first shaft 61 and the one permanent magnet 14. The other partition wall portion 132 is in contact with each of the second shaft 62 and the other permanent magnet 14. The permanent magnets 14 are in contact with each other. Each of the partition wall portions 132 is formed separately from the holding portion 131. In addition, in this case, the plurality of permanent magnets 14 may be integrated. Namely, the motor rotor 11 may include one permanent magnet. In addition, the partition wall portion 132 may not be provided in one of a location between the first shaft 61 and the one permanent magnet 14 and a location between the second shaft 62 and the other permanent magnet 14. Namely, the partition wall portion 132 may be provided between at least one of the first shaft 61 and the second shaft 62 and the permanent magnet 14.

The position of the partition wall portion 132 may be appropriately determined based on various factors such as a mass distribution and an elastic modulus of the motor rotor 11 and a rotation speed of the motor rotor 11 etc.

The motor rotor 11 may include three or more permanent magnets 14. In this case, the partition wall portion 132 may be provided between at least a pair of the permanent magnets 14 adjacent to each other.

A through-hole or the like may be formed in the partition wall portion 132. The partition wall portion 132 may have, for example, an annular shape.

1. A motor rotor comprising:
a holding member which is provided between a first end of a motor housing and a second end of the motor housing;
a first shaft which is provided between the first end of the motor housing and the holding member, and which is inserted into a first opening of the holding member;
a second shaft which is provided between the holding member and the second end of the motor housing, and which is inserted into a second opening of the holding member; and
a magnet member provided between the first shaft and the second shaft in the holding member.

2. The motor rotor according to claim 1,
wherein the holding member comprises:
a holding portion having a tubular shape and comprising the first opening and the second opening; and
a partition wall portion provided between the first opening and the second opening in the holding portion.

3. The motor rotor according to claim 2,
wherein the partition wall portion is located at approximately a center of the holding portion in an axial direction.

4. The motor rotor according to claim 2,
wherein the first shaft is press-fitted into the first opening of the holding portion, and
wherein the second shaft is press-fitted into the second opening of the holding portion.

5. The motor rotor according to claim 2,
wherein the magnet member is press-fitted into the holding portion.

6. The motor rotor according to claim 2,
wherein the magnet member comprises:
a first magnet provided between the first shaft and the partition wall portion in the holding portion; and
a second magnet provided between the partition wall portion and the second shaft in the holding portion.

7. The motor rotor according to claim 2,
wherein the partition wall portion is provided between the first shaft and the magnet member in the holding portion.

8. The motor rotor according to claim 2,
wherein the partition wall portion is provided between the magnet member and the second shaft in the holding portion.

9. The motor rotor according to claim 2,
wherein the partition wall portion comprises:
a first partition wall portion provided between the first shaft and the magnet member in the holding portion; and
a second partition wall portion provided between the magnet member and the second shaft in the holding portion.

10. The motor rotor according to claim 9,
wherein the magnet member comprises:
a first magnet provided between the first partition wall portion and the second partition wall portion; and
a second magnet provided between the first magnet and the second partition wall portion.

11. The motor rotor according to claim 2,
wherein a rigidity of the partition wall portion is larger than a rigidity of the magnet member.

12. The motor rotor according to claim 2,
wherein an elastic modulus of the partition wall portion is larger than an elastic modulus of the magnet member.

13. The motor rotor according to claim 2,
wherein the holding portion and the partition wall portion are formed integrally so as to form a single integral member.

14. The motor rotor according to claim 13,
wherein a material of the single integral member is a non-magnetic metal.

15. The motor rotor according to claim 13,
wherein a natural frequency of the motor rotor is larger than a frequency of the motor rotor when the motor rotor operates at a maximum rotation speed.

16. The motor rotor according to claim 2,
wherein the holding portion and the partition wall portion are formed separately.

17. The motor rotor according to claim 16,
wherein the partition wall portion is press-fitted into the holding portion.

18. The motor rotor according to claim 2,
wherein the partition wall portion comprises a through-hole.

19. A turbocharger comprising:
a turbine impeller;
a compressor impeller;
a holding member which is provided between the turbine impeller and the compressor impeller;
a first shaft which is provided between the turbine impeller and the holding member, and which is inserted into a first opening of the holding member;
a second shaft which is provided between the holding member and the compressor impeller, and which is inserted into a second opening of the holding member; and
a magnet member provided between the first shaft and the second shaft in the holding member.

20. The turbocharger according to claim 19,
wherein the holding member comprises:
a holding portion having a tubular shape and comprising the first opening and the second opening; and
a partition wall portion provided between the first opening and the second opening in the holding portion.
